(19) United States
(12) Patent Application Publication
(10) Pub. No.: US 2018/0323588 A1
(43) Pub. Date: Nov. 8, 2018

(54) A CABLE STRIPPING TOOL FOR ELECTRICAL CABLES

(71) Applicant: HellermannTyton Limited, West Sussex (GB)

(72) Inventors: Steven John Blanks, Cheshire (GB); Anthony Brian Doyle, Stockport (GB)

(21) Appl. No.: 15/773,198

(22) PCT Filed: Nov. 4, 2016
(86) PCT No.: PCT/EP2016/076704

§ 371 Date: May 3, 2018

(30) Foreign Application Priority Data
Nov. 4, 2015 (GB) 1519506.8

(51) Int. Cl. H02G 1/12; H01B 7/36; H01R 13/02; H01R 13/46

(52) U.S. Cl. CPC H02G 1/1224; H02G 1/1241; H01R 13/465; H01R 13/025; H01B 7/368

(57) ABSTRACT

A cable stripping tool for use with electrical cables comprising an inner core and at least one outer sheath. The cable stripper includes a body including a cable retaining portion having a rotational axis defined therethrough. The cable retaining portion is configured to receive a cable such that its longitudinal axis is coaxial with the rotational axis. The cable stripper also includes first and second cutting blades movable transversely relative to the rotational axis between a retracted position and a cutting position, the cutting blades each having a blade edge. The blade edges of the first and second blades are axially spaced from each other relative to the rotational axis and are arranged such that in the cutting position the first cutting blade is spaced a first radial distance from the rotational axis and the second blade is spaced a second radial distance from the rotational axis that is greater than the first radial distance. The cable stripping tool is rotatable about the rotational axis when the cutting blades are in the cutting position to cause the blades to cut around the entire circumference of the cable.

### CROSS-REFERENCE TO RELATED APPLICATIONS

This application is a national stage application under 35 U.S.C. § 371 of PCT Application Number PCT/EP2016/076704 having an international filing date of Nov. 4, 2016, which designated the United States, said PCT application claiming the benefit of Great Britain Patent Application No. 1519506.8, filed Nov. 4, 2015, the entire disclosure of each of which are hereby incorporated herein by reference.

### TECHNICAL FIELD OF THE INVENTION

The present invention relates to a cable stripping tool for electrical cables, and in particular to a tool for stripping and preparing cables for securing to a connector for connection to an electricity meter.

### BACKGROUND OF THE INVENTION

Smart meters enable the measurement and recording of electrical energy consumption of and provide the facility to communicate that information on a real time basis to the consumer. The traditional means of metering electricity usage provides a cumulative measure of consumption that doesn't allow the user to appreciate the varying levels of usage over the time. The information provision of consumption data by smart meters enables users to more easily monitor their consumption and to modify their usage if required. Smart meters also enable consumption data to be communicated directly to the energy companies for monitoring and billing purposes. This ability for direct reporting removes the need for the traditional model of physical meter reading by the utility companies.

Given the clear advantages of smart meters, there has understandably been a move to increase smart meter usage, with a target having been set of smart meters installed in all homes in the UK by 2020. The significant increase in the number of smart meter installations has led to the development of guidelines to ensure that meter installation is performed in a manner that is safe and secure for the installer. Under these guidelines an installed meter must be tamper free and present no risk to the consumer. In particular the opening through which the electrical cables are inserted into the meter must be of sufficient size to accommodate the cable, while also preventing the insertion of additional cables or foreign objects into the meter. As electrical cables can vary is diameter, it is not possible to provide a smart meter casing having a universal opening that satisfies both these requirements. It is also a requirement of the installation guidelines that the electrical cables are clearly marked with an indication of their electrical state i.e. whether the cables are ‘live’ or ‘neutral’, as well as an indication of whether the cables are outgoing or incoming; outgoing cables should be provided with two separate markers incoming cables with a single marker. The current practice of marking cables using cable ties is undesirable as it generates material wastage and debris at the point of use. In addition the rotational position of the cable ties about the cables is not able to be fixed, which prevent the ties from being readable. Furthermore it is also not possible to remove and relocate cable ties as removal requires the ties to be cut.

### BRIEF SUMMARY OF THE INVENTION

The applicant has developed a cable marker and connector arrangement for use in smart meter installation as described in further detail below. The cable marker for cables having a plurality of inner cables surrounded by an outer sheath, comprises a marker element comprising a collar having an external indicia for indicating the electrical state of the cable to which it is connected, and an internal channel extending therethrough between first and second openings at corresponding first and second ends of the collar, the first opening having a first diameter and the second opening having a second diameter less than the first diameter, wherein the channel is stepped in diameter along its length between the first and second diameters, the step in diameter defining an internal abutment to prevent passage of a cable sheath while allowing the internal cables to pass through to the second opening.

In this way, the first marker element forms a cap for the end of the cable arranged such that the inner cables are not visible or accessible at the first end which in use remains external to the meter. The second end is configured to be inserted into the opening of the meter corresponding to the relevant cable, and as such the free ends of the inner cables are externally shielded and only exposed within the enclosure of the meter. The second end is preferable configured to be received in the corresponding opening of the enclosure with a close tolerance fit, which may be an interference fit, and includes a tapered leading edge to facilitate insertion. This cable marker arrangement requires the cable to be stripped in a stepped manner which is compatible with the cable marker. The exponential increase in the number of smart meter installations requires the installer to be able to strip the electrical cables in a consistent and accurate manner while also doing so as quickly and efficiently as possible.

According to the present invention there is provided a cable stropping tool as described in the accompanying claims.

In an embodiment of the invention there is provided a cable stripping tool for use with electrical cables including an inner core and an outer sheath, the cable stripper comprising a body including a cable retaining portion having a rotational axis defined therethrough. The cable retaining portion is configured to receive a cable such that its longitudinal axis is coaxial with the rotational axis. First and second cutting blades are provided which are movable transversely relative to the rotational axis between a retracted position and a cutting position. The cutting blades each have a blade edge. The blade edges of the first and second blades are axially spaced from each other relative to the rotational axis. The blade edges are also arranged such that in the cutting position the first cutting blade is spaced a first radial distance from the rotational axis and the second blade is spaced a second radial distance from the rotational axis that is greater than the first radial distance. The cable stripping tool is rotatable about the rotational axis when the cutting blades are in the cutting position to cause the blades to cut around the entire circumference of the cable.

The radial spacing of the blade edges in the cutting position allows the first cutting blade to be arranged to cut through both the inner and outer sheathes of the cable to the radial depth of the core while the second blade cuts through only the outer sheath. As the blades are axially spaced, once the full cut has been made the inner sheath is cut at the axial position of the first blade, exposing beyond it the inner core. The inner sheath extends to a greater axial length than the outer sheath, which is cut at the axial position of the second blade at a position spaced further along the cable. This forms a stepped arrangement in which the diameter of the cable steps down to that the of the outer surface of the inner sheath at a first axial position, and then steps down to a second diameter corresponding to the diameter of the inner core. The ability of the tool to rotate about the around the rotational axis enables the cutting blades to cut around the entire circumference of the cable once the blades have made the initial insertion on movement to the cutting position.

The stepped configuration of the stripped cable conforms to the inner configuration of the cable markers. The step defined by the cut between the outer surface of the outer sheath and the outer surface of the inner sheath that exposes the inner sheath locates and abuts a first abutment surface within the cable marker. The second step defined by the cut through the inner sheath to the core seats against a second abutment surface within the marker, inwardly of the first abutment surface. This double stepped arrangement within the marker makes it extremely difficult if not impossible to access the core of the cable through the cable marker, thereby ensuring the electrical core is unable to be accidentally or intentionally contacted once the connection portion of the cable marker is inserted into and connected to the housing of electrical meter. The two step arrangement also ensures that the point along the cable at which the core is exposed is spaced inwardly into the cable marker/connector passed the first abutment surface. The arrangement of the blades of the stripping tool ensures a consistent, clean and reproducible cut that ensures the cable always closely and safely fits into the connector. This is especially important where the tool may be used by a non-skilled or newly trained operator as it allows them to produce the required finish on the cable without difficulty.

The cable retaining portion preferably includes a stop member arranged to longitudinally locate the cable when inserted into the cable retaining portion. The stop member enables the cable to be inserted to a consistent and repeatable axial location. This ensures that the length of exposed core created by the removal of the inner sheath is always the same.

Preferably the first cutting blade is arranged longitudinally towards the stop member relative to the second cutting blade. This ensures that the cuts into the inner and outer sheaths are made in the correct order to achieve the required stepped arrangement. The cable retaining portion may comprise a channel extending into the body section having an opening at located at one end for receiving the cable and the opposing end being closed forming the stop member. The cable is inserted into the cylindrical channel which has a diameter substantially equal to the diameter of the cable such that the walls if the channel laterally restrain the cable during cutting. The closed end of the channel may be formed by a wall of the body section or a cap covering the end. The closed end prevents through insertion of the cable and as such defines the stop member. The cable receiving channel preferably comprises a plurality of longitudinally extending and annularly spaced ribs. The inner edges of the ribs define a diameter that is substantially equal to the diameter of the cable. The cable sheath is able to expand in a more consistent manner into the recesses defied by the gaps between the ribs when compressed by the cutting blades. Compression in only a single direction would result in the cable having an oval form which would prevent even cutting on rotation. The ribs therefore achieve a more even cut.

The cable stripping tool may further comprising a blade actuator pivotally mounted to the body section, wherein the cutting blades are mounted to the blade actuator and pivoting of the blade actuator relative to the body section moves the cutting blades between the retracted position and the cutting position.

The body section preferably includes a cylindrical wall defining an aperture through the body section having an axis parallel with and spaced from the rotational axis, the blade actuator being pivotally mounted about the cylindrical wall.

The cable stripping tool may further comprise a stop member arranged to limit rotational movement of the blade actuator between the retracted position and the full cutting position. The stop member preferably extends from the cylindrical wall and is received with a corresponding channel in the blade actuator having a length defining the stop limits.

The cylindrical wall is preferably configured to receive a user's finger and the inner surface defines curved contact surface to be engaged by the user's finger to rotate the tool around the cable.

The cutting blades are preferably circular and arranged concentrically with the first cutting blade having a diameter greater than the second cutting blade, the central axis of the blades being parallel with the rotational axis.

The cutting blades are preferably spaced from the pivotal axis of the blade actuator such that their central axis pivots along an arcuate path that intersects the rotational axis. The blade actuator is housed within the body and includes a trigger portion that projects out of the body section and is arranged to be depressed by a user to move the cutting blades to the cutting position.

The cutting blades may be movable between a retracted position, an intermediate cutting position and a full cutting position, the radial distance of the first and second blades from the rotational axis being greater at the intermediate cutting position than the final cutting position.

The cable stripping tool preferably further comprises a blade actuator to which the cutting blades are mounted and movement of the blade actuator relative to the body section moves the cutting blades between the retracted position, intermediate cutting position and the cutting position, and the tool further includes a releasable locking element arranged such that on movement of the blade actuator from the retracted position to the intermediate position the locking element locks the blade actuator in the intermediate cutting position preventing return to the retracted position, and on further movement of the blade actuator to the full cutting position the locking element locks the blade actuator in the full cutting position preventing return to the intermediate cutting position. The locking element preferably comprises a releasable ratchet arrangement including a first set of teeth connected to the body section and a second set of teeth mounted to the blade actuator, one of the first and second teeth being movable to release the ratchet arrangement.

With reference to the cable marker, the outer surface of the second end of the cable marker collar preferably has a reduced diameter for insertion into the opening the electrical meter enclosure, with the reduction in diameter defining an external abutment shoulder configured to prevent passage of the first end of the collar into the opening with first end extending outwardly of and obscuring the opening in use. As such, even if the second end does not closely fit within the opening to the meter, the opening is covered and obscured by the larger diameter first end of the collar to prevent additional cables or other objects from being inserted.

The channel preferably includes a third diameter section between the first and second diameter sections, the third diameter section having a diameter less than the first diameter and greater than the second diameter, wherein a first abutment shoulder is defined by the step between the first diameter section and the third diameter section, and a second abutment shoulder is defined between the third diameter section and the second diameter section, the first and third diameter sections being configured for accommodating two different sheath diameters. The wider first diameter accommodates larger cables, and preferably has a diameter of 25 mm, with the free end of the sheath abutting the abutment shoulder between the first and third diameter sections. The third diameter section is preferably 16 mm in diameter. 16 mm cables inserted into the collar pass through the first section and are spaced from the wider channel wall of this section. The free end of the sheath then abuts the shoulder defined between the third and second channel sections. The second channel section is only wide enough to accommodate the inner cables. The cable marker arrangement may further include a second marker element configured to be secured to a cable, the second marker element having an external indicia indicating the same electrical state as the indicia of the first marker element, the second marker element configured to be axially slideable along a cable to enable it to be moved into abutment with the first marker element, the first and second marker elements including cooperating locking means to rotationally fix the second mark element relative to the first marker element when the two are brought into axial abutment. The may alternatively or additionally be arranged to axially fix the first and second marker elements. Securing the first and second marker elements rotationally ensures that the indicia of both are visible from the same viewing angle. Axially abutting the first and second marker elements and holding them in this position ensures that it is immediately evident to the installation engineer that two markers are present on the cable, confirming that the cables are outgoing. In contrast, where cable ties are used it is possible that they may slide along the cable such that on first inspection it may appear that only one marker is present in the cable, giving a false impression of the nature of the cable.

One of the first and second marker preferably elements includes an axial projection and the other includes a corresponding axial recess configured to receive the projection arranged such that when the projection is received in the recess relative rotational movement between the two marker elements is prevented. The projection and recess may also be configured to axially secure the two markers together such as by including a close tolerance friction fit.

The projection and recess are preferably arranged to fix the first and second marker elements in a predetermined rotational relationship in which the indicia are arranged in predetermined manner, and preferably in a predetermined rotational relationship such that the indicia of both elements are aligned.

The second marker element preferably comprises a pair of spaced flexible arms interconnected at one end by a bridging section, the free ends of the arms being expandable to receive a cable into the space defined between the two arms. This enables the marker to be secured to the cable in a quick and easy push fit manner that does not require material waste such as in the case of cable ties.

The arms may project from the bridging section in a first section and bend inwardly towards their ends such that the free ends extend in an opposing second direction, the free ends of the arms being located inwardly of the proximal ends of the arms. The free ends flex towards the proximal ends on cable insertion, while the proximal ends also flex outwardly, thereby creating two inwardly directed biasing forces to grip the arms onto the cable. The inner edges of the free ends also face upwardly towards the bridging section when flexed creating an angled biasing force that clamps the cable in position.

The free ends of the arms are spaced from the bridging section.

The free ends of the arms include preferably barbs projecting inwardly and angled towards the bridging section in the second direction, which is in the direction of insertion and opposing the direction of retraction of the cable, to grip and retain a cable received within between the free ends of the arms.

The second marker element preferably further includes a locating arm extending across the space defined between the two arms in a direction substantially parallel with the bridging member and spaced inwardly towards the bridging section away from free ends of the arms, the locating arm being arranged to locate smaller cables in a position where they may be gripped by the free ends of the arms, and being flexible away from the free ends of the arms to accommodate larger cables. The locating arms is preferably curved to accommodate the curved surface of the cable. The arm ensures that smaller diameter cables, and specifically the 16 mm cables are housed closely within the marker element without passing so far in that they are not properly gripped by the gripping arms, and provides a returning biasing force to hold the cable in place. When the larger 25 mm cable are inserted the locating arm flexes away towards the bridging section to provide greater space to accommodate the cable. The locating arm preferably extends from the inner edge of one of the pair of arms, at a position spaced from the bridging section and the free ends of the arms in the insertion direction, and extends laterally relative to the insertion direction towards the other arm, from which it is free and preferably spaced.

The first cable marker element is preferably a single piece molded plastic component and the indicia is integrally molded as part of marker element. The second cable marker element is also preferably a single piece molded plastic component and the indicia is integrally molded as part of marker element. As such the components are cheap to manufacture, and do not require multiple parts that can become separated and/or which require timely assembly at the point of use.

A cable marking kit may also be provided comprising a first pair of first and second cable marking elements as described above having indicia indicating a live cable condition, a second pair of first and second cable marking elements as described above having indicia indicating a neutral cable condition, and a pair of first cable marking elements as described above, one if which has an indicia indicating a live cable condition and the other of which has an indicia indicating a neutral cable condition. There may also be provided a cable marker arrangement comprising a pair of spaced resiliently flexible arms interconnected at one end by a bridging section, the free ends of the arms being expandable to receive a cable into the space defined between the two arms, and configured such that when expanded they impart a returning force to grip the cable.

The arms preferably project from the bridging section in a first section and are bent inwardly towards their ends such that the free ends extend in an opposing second direction, the free ends of the arms being located inwardly of the proximal ends of the arms. The free ends of the arms may include barbs projecting inwardly and angled towards the bridging section in the second direction to grip and retain a cable received within between the free ends of the arms. The second marker element may further include a locating arm extending across the space defined between the two arms in a direction substantially parallel with the bridging member and spaced inwardly towards the bridging section away from free ends of the arms, the locating arm being arranged to locate smaller cables in a position where they may be gripped by the free ends of the arms, and being flexible away from the free ends of the arms to accommodate larger cables.

The locating arm preferably extends from the inner edge of one of the pair of arms and extends towards and is spaced from the other arm. A method of marking cables during installation of an electrical meter comprising:
a) applying a first cable marker element as described above having an indicia indicative of a live cable condition to an ingoing live electrical cable having the cable prepared such that the inner cables extend past the end of the sheath by inserting the cable into the first cable marker element until the sheath abuts the abutment shoulder and the such that the inner cable extend out of the second opening;
b) performing step a) for the ingoing neutral cable wherein the first marker includes an indicia indicative of a neutral cable condition;
c) performing step a) for the outgoing live cable wherein the first marker includes an indicia indicative of a live cable condition;
d) repeating step a) for the outgoing neutral cable wherein the first marker included an indicia indicative of a neutral cable condition;
e) applying a second marker element as described above having an indicia indicative of a live cable condition to the outgoing live cable and moving the first and second marker elements into abutment such that the cooperating rotational locking means rotationally fix the second mark element relative to the first marker element; and
f) applying a second marker element as described above having an indicia indicative of a neutral cable condition to the outgoing neutral cable and moving the first and second marker elements into abutment such that the cooperating rotational locking means rotationally fix the second mark element relative to the first marker element.

The outer surface of the second end of the collar of the first marker elements preferably has a reduced diameter for insertion into an opening an electrical enclosure, the reduction in diameter defining an external abutment shoulder configured to prevent passage of the first end of the collar into the opening with first end extending outwardly of and obscuring the opening in use and wherein step a) further includes inserting the second end of the first marker element into the corresponding opening of the enclosure of the electrical meter until the abutment shoulder abuts the surrounding outer surface of the enclosure and securing the free ends of the inner wires to the electrical meter when the first marker element is in the inserted position.

### BRIEF DESCRIPTION OF THE SEVERAL VIEWS OF THE DRAWING

Other characteristics and advantages of the invention shall appear upon reading the detailed description and the appended drawings, in which:

FIG. 1 shows a smart meter including cable markers according to an embodiment of the invention:

FIG. 2 shows a cable including a first marker element according to an embodiment of the invention:

FIG. 3 shows a plan view of a first marker element according to an embodiment of the invention:

FIG. 4 shows the first marker element of FIG. 3 with a cable inserted;

FIG. 5 shows a first marker element according to an embodiment of the invention:

FIG. 6 shows a second marker element according to an embodiment of the invention:

FIG. 7 shows a first marker element and second marker element according to an embodiment of the invention in alignment;

FIG. 8 shows the first marker element and second marker element of FIG. 7 in abutment;

FIG. 9 shows a plan view of a first marker element and second marker element according to an embodiment of the invention in alignment:

FIG. 10 is shows a cable stripped in accordance with an embodiment of the invention;

FIG. 11 shows a cable marker/connector according to an embodiment of the invention;

FIG. 12 shows a cable stripping tool according to an embodiment of the present invention:

FIG. 13 shows a section view of the tool of FIG. 12;

FIG. 14 shows a further section view of the tool of FIG. 12; and

FIG. 15a-c shows the tool 150 in the retracted condition (15a), the intermediate cutting condition (15b) and the full cutting condition (15c).

### DETAILED DESCRIPTION OF THE INVENTION

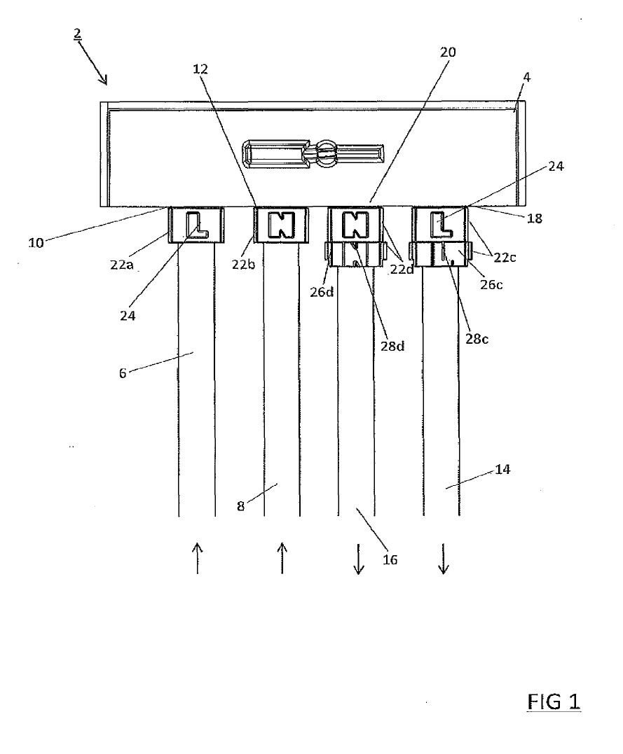

Referring to FIG. 1, a smart electrical meter 2 comprises an enclosure 4 that houses and contains metering means for monitoring electrical consumption and for transmitting that information to the utility company and to the consumer. While the invention is described for use with a smart meter, it will be appreciated that it is not limited to this application and may be used in any application requiring the safe connection of electrical cables into an enclosure. The metering means comprises electrical connection terminals which connect to incoming and outgoing live and neutral electrical cables. The incoming mains supply comprises a live cable 6 and neutral cable 8. The incoming live 6 and neutral 8 enter the meter enclosure 4 through inlet openings 10 and 12 respectively and are secured to the terminals within the enclosure. The outgoing live cable 14 and neutral cable 16 leave the enclosure 4 via outlet openings 18 and 20 and connect to the power circuits of the property.

In accordance with installation guidelines, the cables 6, 8, 14 and 16 are each provided with a first cable marker 22a-d including an indicia 24a-d indicative of the electrical state of the cable, with a ‘L’ indicating the live cables and a ‘N’ indicating the neutral cables. The outgoing live 14 and neutral 16 cables both include a second cable marker 26c and 26d respectively having indicia 28c and 28d matching the indicia of the corresponding first cable marker 22. The presence of two cable markers indicates to the installer the outgoing cables.

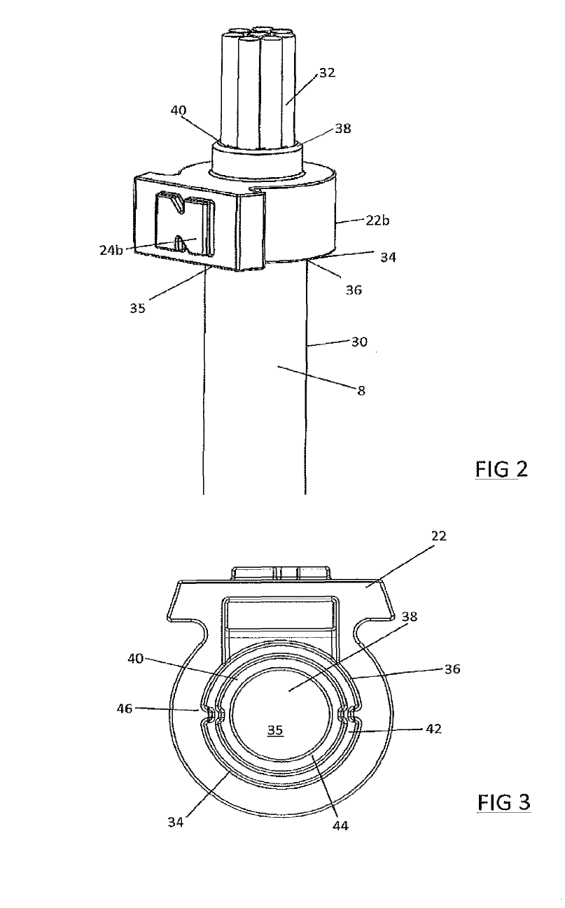

As shown in FIG. 2, each cable includes an outer insulating sheath 30 which surrounds a core comprising a plurality of electrically conductive wires 32. The insulating sheath 30 may be a single layer sheath or may comprises multiple layers. While FIG. 2 shows the incoming neutral cable 8, the same applies for the other cables 6, 14 and 16. The first cable marker 22b caps the cable 8. The cable 8 enters the first marker 22b through an opening 34 located at a first end of the marker 22b. The marker 22b includes a channel 35 extending through the marker 22b, such that the marker 22b is substantially cylindrical and defines a collar surrounding the cable 8. The first end of the channel 36 has a diameter that corresponds to the outer diameter of the sheath 30. The second end 38 has a reduced diameter that is less than the diameter of the sheath 30. As such, in order for the cable to pass through the first marker 22b the cable 8 must be stripped to remove the sheath at its end exposing the inner wires 32 of the core, which are able to pass through the reduced diameter of the second opening 40 at the second end 38.

As shown in FIG. 3, internally the channel 35 includes a first channel section 36 at the first end of the marker 22b comprising the largest diameter section of the channel which in the embodiment shown is 25 mm, corresponding to the diameter of the cable sheath 30. The second channel section 38 at the second end has a second diameter less than the first diameter that prevents the cable sheath from passing through. A third channel section 40 is located axially between the first 34 and second 38 sections. The third channel section 40 has a diameter that is less than the diameter of the first channel section 36 and greater than the diameter of the second channel section 38. In the embodiment shown the diameter of the third channel section 40 is 16 mm.

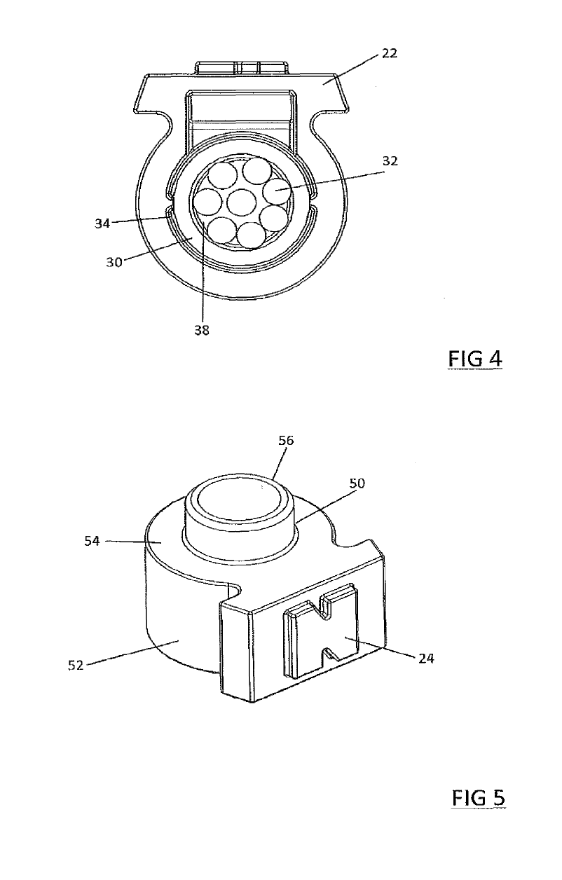

The stepped reduction in diameter between the first channel section 36 and the third channel section 40 creates a first abutment shoulder 42. Similarly, the stepped reduction in diameter between the third channel section 40 and the second channel section 38 defines a second abutment shoulder 44. When a cable having a 25 mm diameter sheath is inserted into the first marker 22 it is accommodated within the first channel section 36 with the outer walls of the sheath 30 closely engaging the walls of the first channel section 36. One or more projections at 46 may extend radially into the first channel section 36 which locally deform the sheath 30 to key and rotationally lock the first marker 22 on to the cable. The axial end surface of the sheath 30 when fully inserted abuts the first abutment shoulder 42, which acts as a stop and prevents further axial travel of the sheath 30 through the marker 22, as shown in FIG. 4. However the bundle of inner cables 32 have a combined diameter which is small enough to allow the cables to pass through the second channel section 38 and extend through the second end of the first marker 22 through the second opening 40. The sheath 30 of the 25 mm may be stripped to include a stepped profile, as will be described in further detail below. The stepped profile creates a first stepped shoulder extending in from the outer edge of the cable to a radial position outwardly of the core 32 corresponding to the diameter of the third channel 40. This shoulder seats against the abutment surface 42. A second shoulder is defined at a stepped location along the cable towards the end of the cable a distance equal to the height of the third channel 40. The second shoulder extends from the inner edge of the first shoulder to the core 32. The second should seats on the abutment surface 44.

The first marker 22 is also able to receive a 16 mm diameter cable. In this arrangement the cable is received within the third channel section 42 without engagement with the walls of the first channel section 34. Again the third channel section 40 may include one or more radially extended projections 46 to rotationally restrain the cable. The end surface of the sheath 30 of the cable engages the abutment surface 42 and in the same way as described above prevents axial travel of the sheath 30 past the abutment shoulder 44 while permitting the inner cables 32 to extend through the second opening 40.

As shown in FIG. 5 the second end 38 of the first marker element 22 includes a reduced external diameter which defines a cylindrical plug section 50. The remainder of the external surface of the first marker 22 has a greater diameter, with the stepped change in diameter between the plug section 50 at the second end and the main body section 52 defining a stepped abutment surface 54 facing axially in the direction of the second end 38. The plug section 50 is configured to be closely received within an opening of the enclosure 4, preferably with a friction fit, and includes a tapered leading edge 56 to facilitate insertion. The abutment surface 54 acts as a stop limiting axial travel of the plug section 50 into the opening through abutment with the outer surface of the enclosure 4. When the plug section 50 is fully inserted into the opening of the enclosure the abutment surface 54 abuts the outer surface of the enclosure 4 with the main body section 52 shielding and obscuring the opening. As such, additional cables or other objects may not be inserted into the opening, and the cables are internally shielded. As can also be seen from FIG. 5, the indicia 24 comprises a raised letter indicating the electrical state of the cable that is integrally molded with the first marker 22.

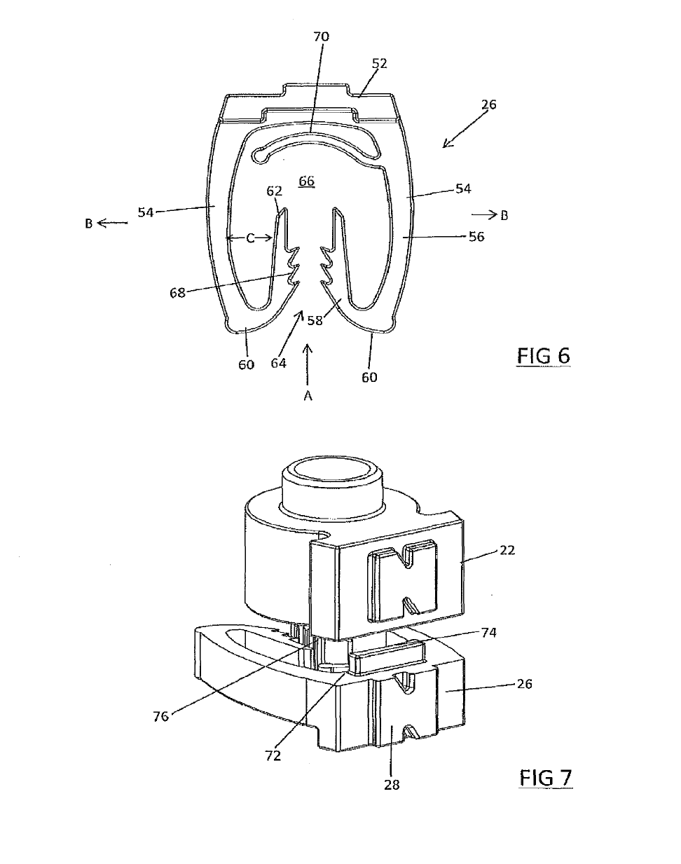

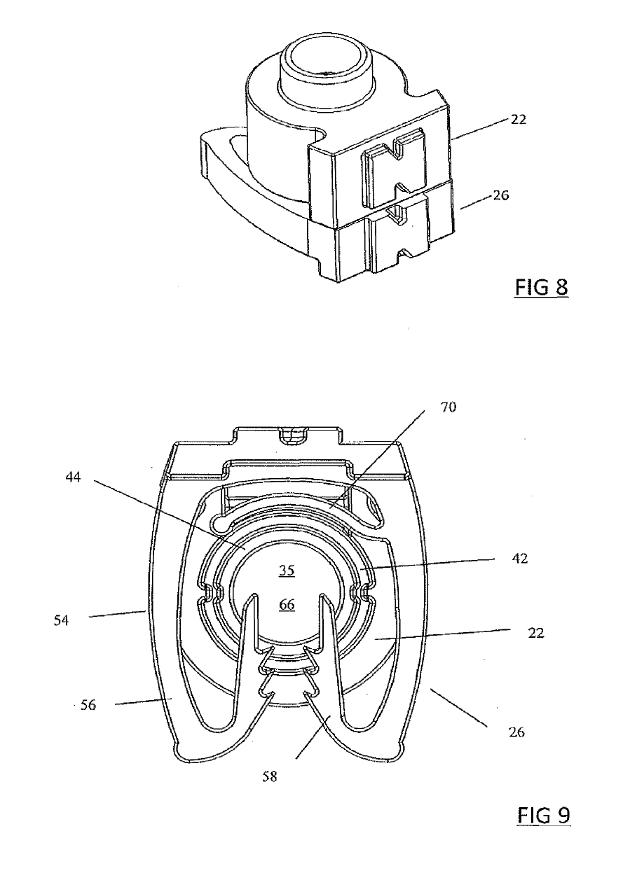

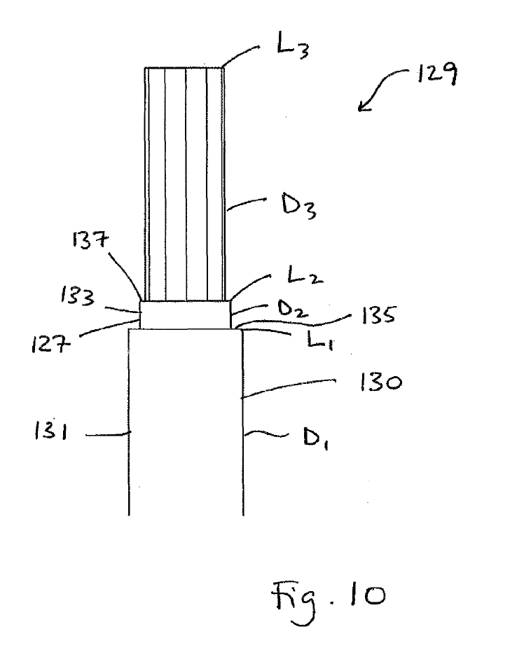

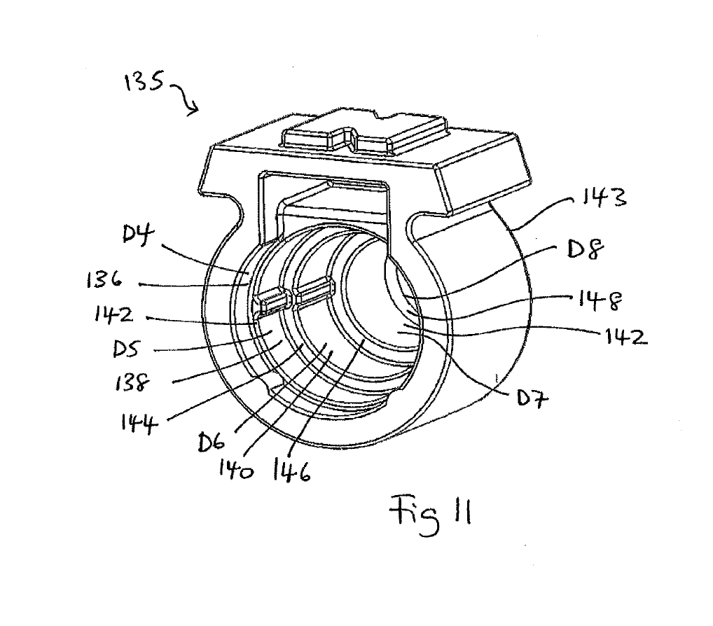

FIG. 6 shows a second marker element 26 in plan view. The second marker 26 includes a bridge section 52 and a pair of flexible arms extending in a substantially perpendicular direction away from opposing ends of the bridge section 52. The flexible arms 54 are slightly convexly curved and include a proximal end section 56 and a distal end section 58. The arms 54 are bent at an elbow 60 along their length through substantially 180 degrees such that distal ends 58 extend in a substantially opposite direction to the proximal ends 56 back towards the bridge section 52. The free ends 62 are spaced from the bridge section 52 and the distal end sections 58 are laterally spaced from each other defining an opening 64 into the space 66 defined between the arms 54 and the bridge 52. The distal ends 58 include barbs 68 located on their inner edges with the barbs of each distal end 58 facing each other. The barbs 68 are angled inwardly towards the bridge section 52 in the insertion direction as indicated by arrow A. In use the marker 26 is pushed on to a cable such that the cable is received within the opening 64. The opening 64 in the closed configuration is significantly narrower than the diameter of the cable to which it is applied. As the second marker 26 is pushed over the cable the arms 54 flex outwardly in a lateral direction as indicated by the arrows B substantially parallel to the length of the bridging section 52 and perpendicular to the insertion direction A. The proximal ends 56 extend outwardly pivoting about their connection with the bridge section 52. The distal ends 58 also pivot about the elbows 60 in the direction B and compress reducing the distance C between their tips 62 and the proximal ends 56 of the arms.

When the cable is fully received within the second marker 26 the resilient arms 54 in their expanded configuration provide a returning force which clamps the arms against the cable. The compressed distal ends 58 are angled in the flexed form such that the end surfaces angle inwardly in the insertion direction A with the cable being inserted a sufficient distance in to the marker 26 that part of the inner surface of the distal sections 56 engage the rear side of the cable relative to the insertion direction A urging the cable into the second marker 26, with the barbs 68 assisting to prevent retraction of the cable. A locating arm 70 is provided within the marker 26 proximate the bridging section 52. The locating arm 70 has a curved profile and is secured at its base to one of the arms 54 and extends across the void within the marker 26 towards the other arm 54 with the end of the locating arm 70 being spaced from the other arm 54. The locating arm 70 is flexible and able to flex in the insertion direction A towards the bridging section 52. The locating arm 70 provides a stop for smaller 16 mm cables. If such smaller cables were to be inserted all the way into the marker such that they abutted the bridge 52 then they would not be adequately gripped by the distal ends 58 of the arms 54. The locating arm 70 limits insertion of the cable and provides a returning biasing force against the cable in a direction opposing the insertion direction A, thereby clamping the cable between the distal ends 58 and the arm 54 and the locating arm 70. Where a large 25 mm cable is inserted into the marker 26 the locating arm is able to flex rearwardly towards the bridging section 52 to accommodate the larger cable.

As shown in FIG. 7 the front surface of the marker 26 includes an integrally molded alphanumeric indicia indicating the electrical condition of the cable to which it is attached. The axially facing upper surface 32 includes axial projection 74 in the form of an elongate spigot. The spigot 74 is configured to be received in a corresponding axially extending recess of the lower surface of 78 of the corresponding first marker 22. The spigot 74 and the recess 76 are located such that when the spigot 74 is received in the recess of 76 the indicia of the first 22 and second 26 markers are aligned. When the spigot 74 is received in the recess 76, relative rotation between the first 22 and second 26 markers is prevented. A friction fit may also be provided between the spigot 74 and the recess 76 such that the two markers are axially held together.

As shown in FIG. 8, when the first 22 and second 26 markers are abutting with the spigot 74 received in the recess of 76 the indicia are co-aligned and it is immediately evident that two markers are provided on the cable. With the cable secured within the enclosure 4 to the electrical terminals the first marker 22 is held in position against the enclosure with the abutment shoulder 54 obscuring the opening. As such, the first marker 22 is axially fixed on the cable and cannot slide out of view. Sliding the second marker 26 into abutment and securement with the first marker also holds the second marker 26 in a position where the indicia is readily viewable at a common viewing angle to the indicia of the first marker 22, as well as preventing the second marker 26 from sliding away from the first marker 22 along with the cable.

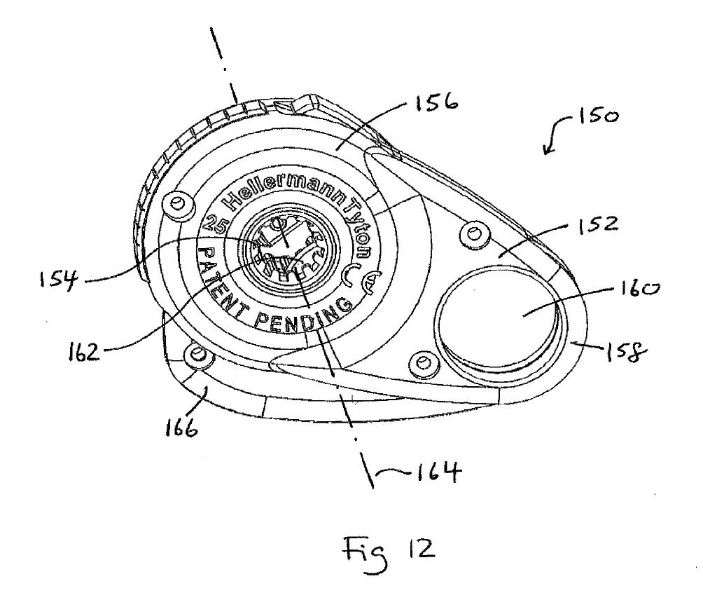

In an alternative embodiment shown in FIG. 10 the cable 129 is stripped in such a manner that the end of the sheath 130 forms a stepped arrangement. The sheath 130 surrounds the core 132 and includes an outer sheath layer 131 and an inner sheath layer 133. The cable 129 is stripped at a first length Li by removing the only the outer sheath layer 131. The cable 129 at this point steps inwardly from an outer diameter Di to an intermediate diameter D2 defining a first shoulder 135. The cable 129 is stripped further at a second length L2 spaced towards the end from first length Li, with a section of inner sheath 127 being exposed between Li and L2. At L2 the inner sheath 133 is stripped further to the core 130 at a diameter D3, defining a second shoulder 137. Alternatively the sheath 130 may be a single layer sheath with material between points Li and L2 and between Di and D2 being sheared away during the stripping process.

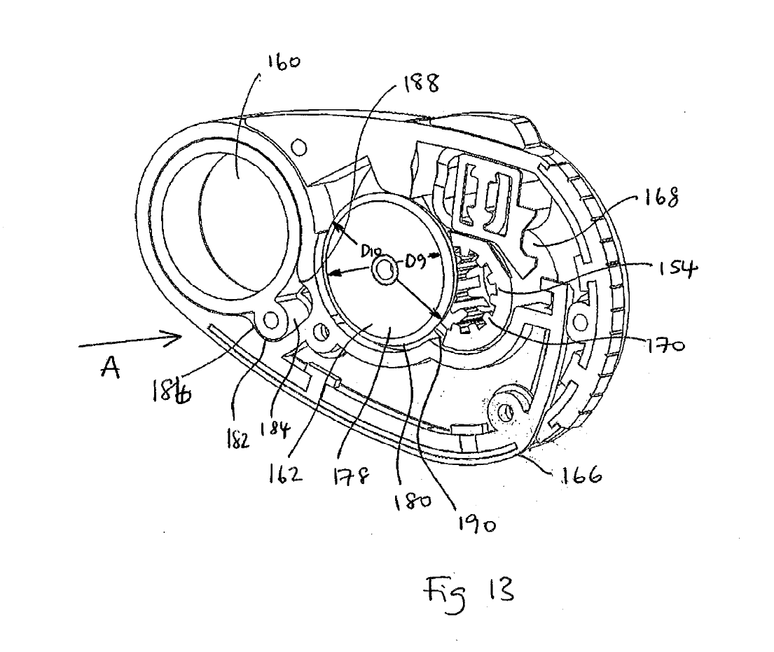

An alternative cable marker/connector 122 is shown in FIG. 11. The cable marker 122 is substantially the same as the marker 22 described above, with the exception that the alternative marker 122 includes additional abutment shoulders to enable the marker to cooperate with stepped cables of both 25 mm and 16 mm diameters. The bore 135 includes a first channel section 136 at the first end of the bore 135 having the largest diameter D4 of the bore 135, which in this embodiment is 25 mm. A second channel section 138 is inwardly adjacent the first channel section 136 in the direction of the end of the inner end 143 of the cable 129. The second channel section 138 has a diameter D5 that is stepped inwardly of the diameter D4 of the first channel section 136. This stepped reduction in diameter forms an abutment shoulder 142. A third channel section 140 is inwardly adjacent the second channel section 138 in the direction of the inner end 143 of the marker 129. The third channel section 140 has a diameter D6 that is stepped inwardly of the diameter D5 of the second channel section 138. This stepped reduction in diameter forms an abutment shoulder 144. A fourth channel section 145 is inwardly adjacent the third channel section 140 in the direction of the inner end 143 of the marker 129. The fourth channel section 145 has a diameter D6 that is stepped inwardly of the diameter D5 of the third channel section 140. This stepped reduction in diameter forms an abutment shoulder 146. The inner end of the bore 135 through which the cable 129 exits the marker 122 has a diameter D9, the step down from diameter D8 to D9 forming an abutment shoulder 148.

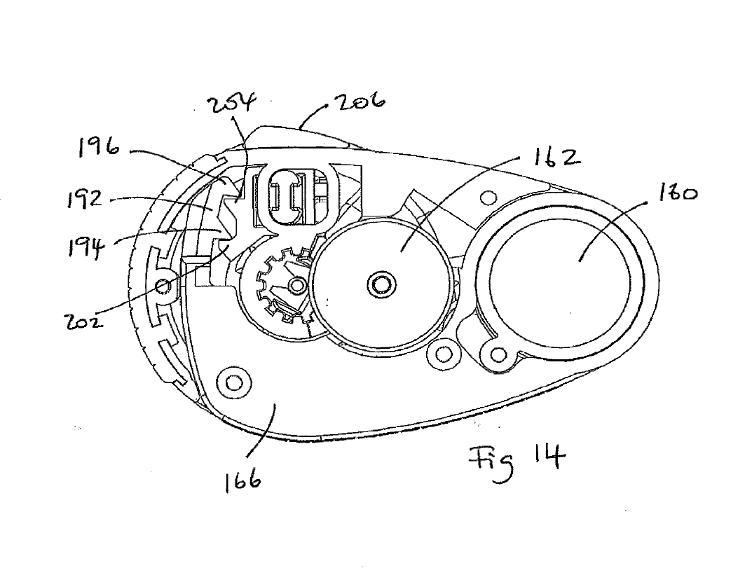

When a stepped cable having a 25 mm outer diameter sheath is inserted into the marker 122 it is accommodated within the first channel section 136 with the outer walls of the sheath 30 closely engaging the D4 diameter wall of the first channel section 136. A projection at 147 extends radially into the first channel section 136 which locally deforms the sheath 130 to key and rotationally lock the marker 122 on to the cable. The first abutment shoulder 135 abuts against the first abutment shoulder 142 of the marker 122. The exposed length 127 of the inner sheath having a reduced diameter D2 equal to the diameter D5 of the second channel section 138 extends into the second channel section 138. The length of the second channel section 138 is equal to the length L2-L1 of the exposed inner sheath section 127 such that the second abutment shoulder 137 seats against and abuts abutment shoulder 144 of the marker 122. Similarly where a 16 mm tie is used the first abutment shoulder 135 of the cable 129 seats on the third abutment shoulder 146 of the maker 122 and the second abutment shoulder 137 seats on the final abutment shoulder 148. The length of the fourth channel 145 is equal to the length of the exposed inner sheath section 127. It is important that the cable 129 is accurately stripped at length locations LI and L2 and that at these points the cable 129 is cut to the diameters D1 and D2 respectively. To avoid human error and lack of consistent reproducibility, FIG. 11 shows a cable stripping tool 150 is provided to strip a cable 129 in the stepped form. The tool 150 comprises a body 152 including a channel 154 extending through body 152 for receiving a cable 129. The diameter of the cable receiving channel 154 is configured to receive a specific diameter cable 129 e.g. 25 mm or 16 mm. The cable channel 154 is centrally located in a substantially circular main body section 156. A handle section 158 extends from the main body section 156 and includes a circular aperture 160 extending therethrough for receiving a user's finger. A pair of circular cutting blades 162 can be seen in FIG. 11 extending into the cable channel 154 transversely to the longitudinal axis 164 of the channel 154. A blade actuator 166 is mounted to the body 152 and as arranged to move the blades 162 into engagement with a cable 129 received within the channel 154. FIG. 13 shows a section view through the tool 150. The channel 154 is formed by a cylindrical wall 168 extending between the side walls of the body section 150. A plurality of annularly spaced ribs 170 extend lengthwise along the inner surface of the channel 154. The aperture 160 in the handle 158 is formed by a cylindrical wall 172. The blade actuator 166 has an aperture 174 formed at one end having a diameter equal to the outer diameter of the wall 172. The blade actuator 166 is pivotally mounted about the wall 172, with the wall 172 being rotationally received within the aperture 174. The wall 172 functions as a spindle about which the blade actuator 166 rotates. The wall 172 is fixed relative to the body section 152 and the blade actuator 166 pivots about the wall 172 relative to the body section 152 in a direction transverse to the longitudinal axis 164 of the cable channel 154.

The circular blades 162 are rotationally mounted to the blade actuator 166 with their rotational axis 176 being arranged parallel to the longitudinal axis of the channel 154 and such that they are arranged transversely to the longitudinal axis 164. The blades 162 are concentric and coaxial. The first blade 178 has a first diameter D9 and the second blade 180 has a second diameter Di0 that is greater than the diameter D9. The difference in diameters D9 and Di0 is selected such that the blade edge of the second blade 180 is spaced radially outwards from the blade edge of the first blade 178 a distance equal to Di-D2, being the radial thickness of the second abutment shoulder 137 which also corresponds to the thickness of the inner sheath 133 of the cable 129. The blades 178, 180 are axially spaced by a distance equal to the length of the exposed inner sheath section 127.

Rotation of the blade actuator 166 about the wall 172 of the aperture 160 pivots the blades 162 along an arcuate path towards and away from the channel 154 in a plane transverse to the longitudinal axis 164 of the channel 154. When a cable 129 is received in the channel 154 the outer surface of the cable 129 engages the inner edges of the ribs 170 which are sized such that their inner edges define an inner diameter to the channel 154 that is equal to the relevant cable diameter. The blade actuator 166 is configured to pivot the blades 162 to a first cutting position as shown in FIG. 12. In this position the blades 162 extend into the channel 154 with the first blade extending into the channel 154 to a radial distance corresponding to the outer surface of the core i.e. to diameter D3 of the cable 129. The first blade 178, by virtue of the radial spacing of its blade edge from the blade edge of the larger blade 180 extends to a position corresponding to the outer surface of the inner sheath 133 i.e. to diameter D2 of the cable 129. The cable is inserted into the channel 154 in an insertion direction A. A stop member limits the distance the cable 129 extends into the channel 129. The larger blade 180 is located away from the first blade 178 in the insertion direction towards the end of the cable 129 and towards the stop member. The stop member is configured to stop the end of the cable 129 a distance from the second blade 180 equal to L3-L2, this distance determining the length of the core 132 that is exposed. The stop member is preferably axially aligned with the channel 154 and includes an axially extending stop element formed of metal and having a diameter selected to be equal to or less that the diameter D3 of the core 132 of the cable 129. This prevents wear of any plastic components by the core 132, and also ensures that the exposed length of the stripped core is consistent and not effected by a poor cut at the end of the sheath.

In the fully retracted position of the blade actuator 166 the second blade 180 is located at a radial distance from the longitudinal axis greater than or equal to the inner diameter of the channel 154 as defined by the inner edges of the ribs 170 such that a cable 129 may be inserted into the channel 154 with interference with the blades 162. A stop member 182 extends radially outwards from the wall 172. The stop member 182 is received with a channel 184 in the body of the blade actuator 166 defined by a recess in the circular inner wall that surrounds the wall 172. The end walls 186 and 188 of the recess engage with the stop member 182 to limit rotation of the blade actuator 166. The spacing and angular location the end walls 186 and 188 define the stop positions of the fully cutting position and the fully retracted position respectively. As can be seen in the section view of FIG. 12, a circumferential slot 190 is formed in the channel wall 168 to accommodate the blades 162 as they move into and out of the channel 154. The length of the slot 190 may also be selected to limit the extent to which the blades may extend into the channel 154.

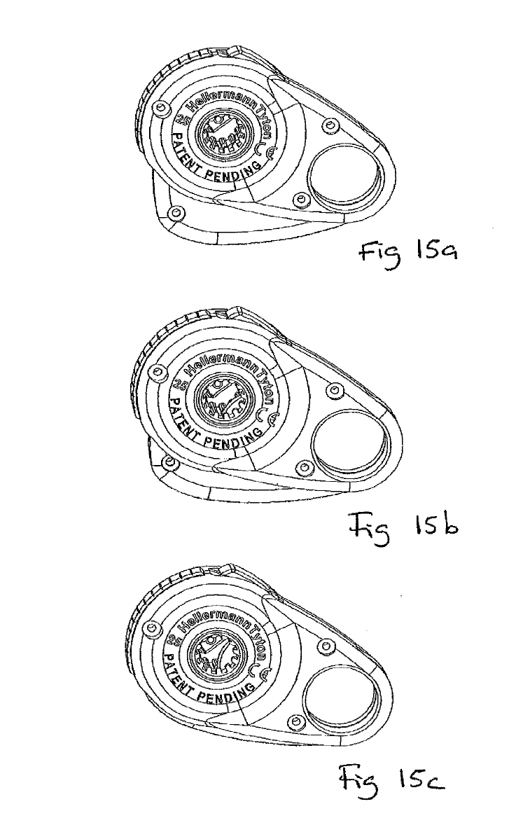

Referring to FIG. 14, the blade actuator 166 includes a locking arm 192 arranged at its end 193 spaced from the pivot axis defined by the rotational mounting about the aperture 160. The locking arm extends substantially circumferentially along a radial arc and locking teeth 196 and 198 project radially inwards from the locking arm 192 and are spaced from each other along the locking arm 192. A latch 200 mounted to the body section 152 includes a corresponding pair of locking teeth 202 and 204 extending in the opposing direction. The locking arm 162 and the latch 200 are arranged such that when the blade actuator 166 is in the retracted position the locking arm 192 is spaced from the latch 200. In the retracted position a portion of the actuator 166 projects outwardly of the body 152 defining a depressible trigger portion. The user places grips the body 152 along its opposing side edges and grips the trigger. As the trigger is squeezed the blade actuator 166 pivots inwardly into the body 152. As it pivots inwardly the first locking tooth 196 of the locking arm 192 comes into engagement with the first locking tooth 202 of the latch 200. The latch 200 is linearly slideable towards and away from the locking arm 192 between a locked and release position and is biased to the locked position with a slider switch 206 being provided to operate the latch 200.

The teeth 194, 196 and 202,204 include corresponding sloping camming surfaces on their leading edges such that as the first tooth 196 contacts the first tooth 202 of the latch the teeth cooperate to slide the latch 200 towards the release position to allow the tooth 196 to move past the tooth 202. Once past the biased latch returns to the locked position and the tooth 196 is latched against tooth 202 in a ratchet manner. The latch 200 and the locking arm 192 are arranged such that this first engagement corresponds to an intermediate rotational position of the actuator 166 in which the blades extend partially into the channel 154 but not to the full cutting position.

With the blades 162 penetrating the sheath 130 of the cable 129 to a partial cutting depth the user grips the cable 129 with a first hand and the inner surface of the wall 172 of the handle 158 with their finger and uses the handle 158 to rotate the tool 150 around the cable 129. The longitudinal axis of the channel 154 defined the rotational axis of the tool 150. Rotation of the tool 150 around the cable 129 causes the blades 162 to effect a fully circumferential cut, meaning a cut that extends a full 360 degrees around the cable. The partial extension of the blades 162 to the intermediate cutting position makes this fits cutting operation easier with deformation of the cable being limited during the cut. The trigger is then further depressed moving the locking arm to a second locking position corresponding to the full cutting position of the blades 162, in which the first locking tooth 196 of the locking arm moves into engagement with the second locking tooth 204 of the latch, and the second locking tooth 194 of the locking arm 192 moves into engagement with the first latch tooth 202. The rotational cutting process is then repeated, with the tool preferably being rotated several rotations to effect a complete cut. Following the second cutting operation the cable may be retracted from the channel 154. Retracting the cable 129 with the blades 162 still in the full cutting position causes the blades 162 to axially retain the cut portions of the sheath within the channel such that the cable is retracted in a fully stripped state. The slide switch 206 of the latch 200 is then operated to return the actuator 166 to the retracted position. This also acts to release the stripped sections of the sheath.

FIG. 15a-c shows the tool 150 in the retracted condition (15a), the intermediate cutting condition (15b) and the full cutting condition (15c). While endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A cable stripping tool for use with electrical cables comprising an inner core and an outer sheath, said cable stripping tool comprising:
a body including a cable retaining portion having a rotational axis defined therethrough, wherein the cable retaining portion is configured to receive a cable such that a longitudinal axis of the cable is coaxial with the rotational axis; and
first and second cutting blades movable transversely relative to the rotational axis between a retracted position and a cutting position, the first and second cutting blades each having a blade edge;
wherein the blade edge of the first and second cutting blades are axially spaced from each other relative to the rotational axis and are arranged such that, in the cutting position, the first cutting blade is spaced a first radial distance from the rotational axis and the second cutting blade is spaced a second radial distance from the rotational axis that is greater than the first radial distance, wherein the cable stripping tool is rotatable about the rotational axis when the first and second cutting blades are in the cutting position to cause the first and second cutting blades to cut the outer sheath around an entire circumference of the cable.

2. The cable stripping tool according to claim 1, wherein the cable retaining portion includes a stop member arranged to longitudinally locate the cable when inserted into the cable retaining portion.

3. The cable stripping tool according to claim 2, wherein the first cutting blade is longitudinally closer to the stop member than the second cutting blade.

4. The cable stripping tool according to claim 2, wherein the cable retaining portion comprises a channel extending into a body section having an opening at located at one end configured to receive the cable and an opposing end that is closed, thereby forming the stop member.

5. The cable stripping tool according to claim 4, wherein the channel comprises a plurality of longitudinally extending and annularly spaced ribs.

6. The cable stripping tool according to claim 4, further comprising a blade actuator pivotally mounted to the body section, wherein the first and second cutting blades are mounted to the blade actuator, and wherein pivoting of the blade actuator relative to the body section moves the first and second cutting blades between the retracted position and the cutting position.

7. The cable stripping to according to claim 6, wherein the body section includes a cylindrical wall defining an aperture through the body section having an aperture axis parallel with and spaced from the rotational axis, the blade actuator being pivotally mounted about the cylindrical wall.

8. The cable stripping tool according to claim 7, further comprising the stop member arranged to limit a rotational movement of the blade actuator between the retracted position and the cutting position.

9. The cable stripping tool according to claim 8, wherein the stop member extends from the cylindrical wall and is received with a corresponding channel in the blade actuator having a length defining stop limits.

10. The cable stripping tool according to claim 7, wherein the cylindrical wall is configured to receive a user's finger and an inner surface of the cylindrical wall defines a curved contact surface configured to engage the user's finger to rotate the cable stripping tool around the cable.

11. The cable stripping tool according to claim 6, wherein the first and second cutting blades are circular and arranged concentrically, wherein the first cutting blade has a diameter greater than the second cutting blade, and wherein a central axis of the first and second cutting blades is parallel with the rotational axis.

12. The cable stripping tool according to claim 11, wherein the first and second cutting blades are spaced from a pivotal axis of the blade actuator such that the central axis of the first and second cutting blades pivots along an arcuate path that intersects the rotational axis.

13. The cable stripping tool according to claim 12, wherein the blade actuator is housed within the body and includes a trigger portion that projects out of the body section and is arranged to be depressed by a user to move the first and second cutting blades to the cutting position.

14. The cable stripping tool according to claim 4, wherein the first and second cutting blades are movable between the retracted position, an intermediate cutting position and the cutting position and wherein a radial distance of the first and second cutting blades from the rotational axis is greater at the intermediate cutting position than the cutting position.

15. The cable stripping tool according to claim 14, further comprising a blade actuator to which the first and second cutting blades are mounted, wherein movement of the blade actuator relative to the body section moves the first and second cutting blades between the retracted position, the intermediate cutting position, and the cutting position, said cable stripping tool further comprising a releasable locking element arranged such that movement of the blade actuator from the retracted position to an intermediate position the locking element locks the blade actuator in the intermediate cutting position, thereby preventing return to the retracted position, and further movement of the blade actuator to the cutting position causes the locking element to lock the blade actuator in the cutting position, thereby preventing return to the intermediate cutting position.

16. The cable stripping tool according to claim 15, wherein the locking element comprises a releasable ratchet arrangement including a first set of teeth connected to the body section and a second set of teeth mounted to the blade actuator, one of the first and second set of teeth being movable to release the ratchet arrangement.
